(19) United States
(12) Patent Application Publication
(10) Pub. No.: US 2019/0285217 A1
(43) Pub. Date: Sep. 19, 2019

(54) PLUG PART FOR A PLUG-AND-SOCKET COUPLING AND PLUG-AND-SOCKET COUPLING HAVING A PLUG PART

(71) Applicant: Alfred Kärcher SE & Co. KG, Winnenden (DE)

(72) Inventors: David Ruckwied, Asperg (DE); Ralph Seitter, Backnang (DE)

(21) Appl. No.: 16/431,308

(22) Filed: Jun. 4, 2019

Related U.S. Application Data
(63) Continuation of application No. PCT/EP2016/079763, filed on Dec. 5, 2016.

(51) Int. Cl. F16L 37/22

(52) U.S. Cl. CPC F16L 37/22

(57) ABSTRACT

A plug part for a plug-and-socket coupling for liquid conduits of a high-pressure cleaning apparatus is provided. The plug part forms a plug nipple, insertable into and disconnectably latchable with a plug receptacle of a socket part. The plug nipple includes a circular-cylindrical first sliding guide section in which is arranged a sealing ring groove extending therearound with a sealing ring therein, and a circular-cylindrical second sliding guide section with a latching receptacle therein configured as a locking groove extending therearound, into which are latchable two spring-loaded cylindrical locking pins of the socket part oriented parallel and diametrically opposite one another. The external diameter of the second sliding guide section is at least one-quarter larger than the external diameter of the first sliding guide section. The distance between the sealing ring and locking grooves is at least one and a half times the first sliding guide section external diameter.

### CROSS-REFERENCE TO RELATED APPLICATIONS

This application is a continuation of international application number PCT/EP2016/079763 filed on Dec. 5, 2016, which is incorporated herein by reference in its entirety and for all purposes.

### BACKGROUND OF THE INVENTION

The invention relates to a plug part for a plug-and-socket coupling for liquid conduits of a high-pressure cleaning apparatus, wherein the plug part comprises a through-channel for liquid under high pressure extending coaxially with respect to the longitudinal axis of the plug part and wherein the plug part forms a plug nipple which is insertable into an associated plug receptacle of a socket part of the plug-and-socket coupling, forming a liquid-tight connection, and is disconnectably latchable together with the plug receptacle, wherein the plug nipple comprises a circular-cylindrical first sliding guide section in which is arranged a sealing ring groove extending therearound in a circumferential direction, said sealing ring groove having a sealing ring therein, and wherein the plug nipple comprises a circular-cylindrical second sliding guide section and a latching receptacle into which are latchable two spring-loaded cylindrical locking pins of the socket part that are oriented parallel to each other and lie diametrically opposite one another.

The invention further relates to a plug-and-socket coupling for liquid conduits of a high-pressure cleaning apparatus having such a plug part.

Plug-and-socket couplings are utilized in high-pressure cleaning apparatuses in order to enable liquid conduits to be connected together in a liquid-tight and disconnectable manner. By use of a plug-and-socket coupling, it is for example possible for a high-pressure hose to be connected to a high-pressure cleaning appliance and it is also possible for a disconnectable and liquid-tight connection to be established between the high-pressure hose and a liquid discharge device, in particular a spray gun. Such plug-and-socket couplings also allow for a disconnectable and liquid-tight connection to be established between a spray gun and a spray lance and between a spray lance and a spray nozzle. The plug-and-socket couplings can be disconnected again by the user as required.

Plug-and-socket couplings of the type discussed here are used for liquid conduits of high-pressure cleaning apparatuses, wherein the liquid present in the liquid conduits can be at a very high pressure, for example a pressure of more than 150 bar, in particular a pressure of 300 bar or even 350 bar. In particular, short-term pressure peaks of more than 300 bar can be encountered in high-pressure cleaning apparatuses. Such pressure peaks can occur, for example, when the user closes a valve of a liquid discharge conduit in order to interrupt the discharge of liquid.

Plug-and-socket couplings for liquid conduits of a high-pressure cleaning apparatus usually comprise a plug part and a socket part that can be inserted one into the other in order to establish a disconnectable liquid-tight connection and that can be latched together to prevent inadvertent disconnection of the connection between the plug part and the socket part, wherein inadvertent disconnection while under high pressure peaks is also to be reliably prevented.

A plug part known from WO 2007/076906 A1 comprises a through-channel for liquid under high pressure that extends coaxially with the longitudinal axis of the plug part and forms a plug nipple which, for establishing a liquid-tight and disconnectable connection, can be inserted into a complementarily configured plug receptacle of a socket part of the plug-and-socket coupling, with a sealing ring interposed therebetween, and can be disconnectably latched together with the plug receptacle. In order for the plug nipple to be able to be introduced into the plug receptacle, it comprises a circular-cylindrical sliding guide section which cooperates with a receiving section of the plug receptacle in a form-locking manner by being capable of being slidingly contactable against the receiving section. For establishing the liquid-tight connection, the sliding guide section has arranged therein a sealing ring groove which is closed upon itself, extends therearound in a circumferential direction and receives a sealing ring.

In Publication Nos. U.S. Pat. Nos. 2,913,263 A, 3,468,562 and WO 80/01311 A1, it is proposed that the sealing ring groove be arranged not on the outer side of the plug nipple but on the inner side of the receiving section of the socket part. This, however, is disadvantageous because it makes it difficult to replace the sealing ring which is positioned in the sealing ring groove.

The plug part known from WO 2007/076906 A1 comprises, in addition to a first sliding guide section in which the sealing ring groove including the sealing ring is arranged, a second sliding guide section which cooperates in a form-locking manner with a second receiving section of the plug receptacle of the socket part. The second sliding guide section is also of circular-cylindrical configuration. This has the advantage that the plug nipple need not assume a predetermined rotational position relative to the plug receptacle in order for it to be able to be inserted into the plug receptacle.

The second sliding guide section known from WO 2007/076906 A1 is configured in the form of a bead which forms on the rear side thereof facing away from the free end of the plug nipple an undercut oriented perpendicularly to the longitudinal axis of the plug part, behind which undercut can engage two spring-loaded cylindrical locking pins of the socket part that are oriented parallel to each other and lie diametrically opposite one another. The insertion of known plug nipples into the complementarily configured plug receptacle of a socket part is frequently rendered difficult because there is a risk of the plug nipple canting. Therefore, the plug nipple needs to be inserted very carefully by the user, wherein the longitudinal axis of the plug nipple must be oriented collinearly with respect to the longitudinal axis of the plug receptacle. This renders the handling of known plug parts difficult. In particular, a one-handed operation of the plug part in establishing the connection thereof with a complementarily configured plug receptacle is frequently not readily possible.

As has been mentioned at the outset, it is to be ensured that the plug part inserted in and latched together with the plug receptacle is not inadvertently disconnected from the plug receptacle. In particular, this requirement for the plug part also applies in instances where the plug part is subjected not only to an axial mechanical load as caused by the pressure of the liquid but additionally to a transverse mechanical load oriented transversely to the longitudinal axis of the plug part. Such transverse loads can occur for example where a liquid-tight connection is established via the plug part with a liquid discharge device, for example a spray lance of considerable extent and considerable weight which is moved along an object that is to be cleaned. As the spray lance is moved, the plug nipple of the plug part is subjected to considerable transverse loads which entail the risk of the plug part being inadvertently disconnected from the socket part.

It is therefore an object of the present invention to improve a plug part of the type mentioned at the outset and a plug-and-socket coupling for liquid conduits of a high-pressure cleaning apparatus having such a plug part in a manner such that the plug part does not cant when inserted into an associated plug receptacle and also is not inadvertently disconnected from the plug receptacle.

### SUMMARY OF THE INVENTION

This object is accomplished, in accordance with the invention, in a plug part of the generic type in that the second sliding guide section has an external diameter which is at least one-quarter larger than the external diameter of the first sliding guide section and in that the latching receptacle is arranged in the second sliding guide section and is configured as a locking groove extending therearound in a circumferential direction, wherein the distance between the center of the sealing ring groove and the center of the locking groove is at least one and a half times the external diameter of the first sliding guide section.

The plug part in accordance with the invention comprises a first sliding guide section and a second sliding guide section, wherein arranged in the first sliding guide section is a sealing ring groove for receiving a sealing ring and arranged in the second sliding guide section is a locking groove for receiving two cylindrical locking pins that lie opposite each other. The external diameter of the second sliding guide section is at least one-quarter larger than the external diameter of the first sliding guide section, and the distance between the center of the sealing ring groove and the center of the locking groove is at least 1.5 times the external diameter of the first sliding guide section. It has been shown that a plug part configured in this manner can easily be inserted into an associated plug receptacle by the operator using just one hand, with practically no risk of the plug part canting. In addition, in a plug part configured in this manner there is practically no risk of the latched connection between the plug nipple and the plug receptacle being inadvertently disconnected. Even when considerable transverse loads occur and in particular also when considerable alternating loads occur in both axial and radial directions relative to the longitudinal axis of the plug part, there is practically no risk of the connection between the plug part and the socket part being inadvertently disconnected.

The risk of the plug part canting when being inserted into the plug receptacle is minimized, among other things, by the fact that in addition to a first sliding guide section having a first external diameter, a second sliding guide section is used whose external diameter is at least 1.25 times the external diameter of the first sliding guide section. In particular, provision may be made for the external diameter of the second sliding guide section to be at least 1.3 times the external diameter of the first sliding guide section. The first sliding guide section may have an external diameter of 12 mm for example, and the second sliding guide section may have an external diameter of 16 mm for example.

A plug receptacle that matches the plug part in accordance with the invention comprises a first receiving section which is configured complementarily to the first sliding guide section of the plug part, and comprises a second receiving section which is configured complementarily to the second sliding guide section of the plug part. When the plug nipple is introduced into the plug receptacle, the first sliding guide section can first be passed through the second receiving section of the plug receptacle in radially spaced relation thereto and then the plug nipple can be introduced with its first sliding guide section into the first receiving section of the plug receptacle. Preferably, the second sliding guide section enters the second receiving section at the time the first sliding guide section enters the first receiving section so that, as the plug nipple continues to be introduced into the plug receptacle, the first sliding guide section slides along the inner side of the first receiving section and the second sliding guide section slides along the inner side of the second receiving section until the sealing ring arranged in the first sliding guide section reaches its sealing position and the locking groove arranged in the second sliding guide section reaches its locking position in which the spring-loaded cylindrical locking pins of the socket part which are oriented parallel to each other and lie diametrically opposite one another latch into place in the locking groove.

The distance between the center of the sealing ring groove receiving the sealing ring and the center of the locking groove receiving the two locking pins is at least 1.5 times the external diameter of the first sliding guide section. In the case of transverse loading in particular, the first sliding guide section is supported at least in the region of the sealing ring groove on the inner side of the complementarily configured first receiving section of the plug receptacle and the second sliding guide section is supported at least in the region of the locking groove on the inner side of the complementarily configured second receiving section of the plug receptacle. The plug part in accordance with the invention is thus reliably supported on two support regions, spaced apart from each other in the axial direction, on the plug receptacle of the socket part. The distance between the two support regions is at least one and a half times the external diameter of the first sliding guide section. The relatively large distance imparts high mechanical stability to the connection between the plug part and the socket part so that the plug part is not inadvertently disconnected from the socket part when transverse loads occur.

Thus, the plug part in accordance with the invention is distinguished by simple handling when establishing a liquid-tight connection to a socket part and is further advantageous in that the plug part is not inadvertently disconnected from the socket part.

Preferably, the distance between the center of the sealing ring groove and the center of the locking groove is at least twice the external diameter of the first sliding guide section. By way of example, said distance is 2.0 times to 2.5 times the external diameter of the first sliding guide section.

It is advantageous for the external diameter of the second sliding guide section to be no greater than one and a half times the external diameter of the first sliding guide section. A relatively large external diameter of the second sliding guide section has as a consequence that the locking pins of the socket part which in the locking position latch into place in the locking groove must be of considerable length because they have their free ends protrude from the locking groove. The longer the locking pins, the greater the risk of them bending when the plug part is loaded by high axial forces resulting from, for example, high pressure peaks.

On the other hand, the external diameter of the second sliding guide section cannot be chosen to be arbitrarily small, as otherwise the latched connection between the locking pins and the locking groove cannot be configured to be mechanically stable. In addition, it is to be ensured that the external diameter of the second sliding guide section is larger than the external diameter of the first sliding guide section, as otherwise there is a risk of the plug part canting. Therefore, in an advantageous embodiment of the invention, provision is made for the external diameter of the second sliding guide section to be at least 1.25 times and at most 1.5 times the external diameter of the first sliding guide section.

In a particularly preferred configuration of the invention, the external diameter of the second sliding guide section is one-third larger than the external diameter of the first sliding guide section.

As has already been mentioned, the plug part has extending therethrough in the longitudinal direction a through-channel for liquid under high pressure. It is advantageous for the through-channel to comprise a cylindrical flow cross section at least in the area of the plug nipple, wherein the internal diameter of the through-channel is half the size of the external diameter of the first sliding guide section. Such diameter ratios allow the sealing ring groove to be arranged in the first sliding guide section using a simple structure without thereby impairing the mechanical stability of the plug part. The internal diameter of the through-channel may, for example, be 6 mm in the area of the plug nipple.

In an advantageous configuration of the invention, the plug nipple comprises a transition section between the first sliding guide section and the second sliding guide section. As mentioned, the external diameters of the first and second sliding guide sections differ. The provision of the transition section allows the external diameter of the first sliding guide section to be adapted to the external diameter of the second sliding guide section with increasing distance to the free end of the plug nipple. The external diameter of the plug nipple thus changes within the transition section extending over a certain axial length.

Advantageously, the external diameter of the transition section increases continuously with increasing distance to the free end of the plug nipple.

In particular, provision may be made for the transition section to be of conical configuration.

It is advantageous for the plug nipple to comprise at the free end thereof an end face whose distance to the end of the transition section facing away from the end face is at least twice the size of the external diameter of the first sliding guide section. The transition section adjoins the first sliding guide section in the direction facing away from the free end of the plug nipple and extends as far as the second sliding guide section. The first sliding guide section and the transition section together advantageously have a length relative to the longitudinal axis of the plug part that is at least 2 times the external diameter of the first sliding guide section.

For example, provision may be made for the distance between the end face of the plug nipple and the end of the transition section facing away from the end face to be approximately 2.5 times the external diameter of the first sliding guide section.

Advantageously, the length of the transition section relative to the longitudinal axis of the plug part is considerably shorter than the length of the first sliding guide section. For example, provision may be made for the first sliding guide section to be least three times as long as the transition section.

In an advantageous configuration of the invention, the first sliding guide section forms a first sliding guide region and a second sliding guide region, wherein the first sliding guide region is arranged on the side of the sealing ring groove facing towards the free end of the plug nipple and wherein the second sliding guide region is arranged on the side of the sealing ring groove facing away from the free end of the plug nipple. With such a configuration, the first sliding guide section extends on both sides of the sealing ring groove, wherein the first sliding guide section forms a first sliding guide region on the side of the sealing ring groove facing towards the free end of the plug nipple and forms a second sliding guide region on the opposite side of the sealing ring groove. The two sliding guide regions are each of circular-cylindrical configuration and are of the same external diameter. As the plug nipple is inserted into an associated plug receptacle, the two sliding guide regions come into contact against the inner side of the associated first receiving section of the plug receptacle one after the other.

It is advantageous for the first sliding guide region to be longer than the second sliding guide region. This has the advantage of allowing the plug nipple, when being inserted into the plug receptacle, first to be inserted with the relatively long first sliding guide region into the associated first receiving section of the plug receptacle; then the sealing ring arranged between the first sliding guide region and the second sliding guide region also enters the first receiving section of the plug receptacle and, when the plug nipple continues to be inserted into the plug receptacle, the second sliding guide section also enters the first receiving section of the plug receptacle.

In an advantageous configuration of the invention, the second sliding guide section forms a third sliding guide region and a fourth sliding guide region, wherein the third sliding guide region is arranged on the side of the locking groove facing towards the free end of the plug nipple and wherein the fourth sliding guide region is arranged on the side of the locking groove facing away from the free end of the plug nipple. With such a configuration, the second sliding guide section extends on both sides of the locking groove, i.e. the locking groove is, in an axial direction, arranged neither directly at the front end of the second sliding guide section facing towards the free end of the plug nipple nor at the rear end of the second sliding guide section facing away from the free end of the plug nipple. The second sliding guide section forms a third sliding guide region on the side of the locking groove facing towards the free end of the plug nipple and a fourth sliding guide region on the opposite side of the locking groove. When the plug nipple is inserted into the associated plug receptacle, the third sliding guide region meets the associated second receptacle section of the plug receptacle, and as the plug nipple continues to be inserted into the plug receptacle, the third sliding guide region then slides along the inner side of the second receptacle section until the locking groove then also enters the second receptacle section, and then the fourth sliding guide region also slides along the inner side of the second receptacle section until the locking pins latch into place in the locking groove.

It is advantageous for the third sliding guide region to be longer than the fourth sliding guide region.

In an advantageous configuration of the invention, the locking groove comprises a conical wall section which adjoins the third sliding guide region and the diameter of which decreases with increasing distance from the third sliding guide region and which is adjoined by an arcuate wall section of the locking groove. The provision of a conical wall section adjoining the third sliding guide region in an axial direction facilitates the latching into place of the locking pins in the locking groove.

Preferably, the arcuate wall section of the locking groove adjoining the conical wall section in an axial direction is configured, in cross section, in the shape of a circular arc. Preferably, this allows the cylindrical locking pins to lie, at least in portions thereof, in surface contact with the wall of the locking groove formed, in cross section, in the shape of a circular arc.

It is advantageous for the cone angle of the conical wall section to be at least 90°, in particular more than 90°. Here, the term “cone angle” is used to denote the opening angle of the conical wall section. The conical wall section forms a frustoconically shaped portion of the locking groove. At a cone angle of more than 90°, the curved surface of the truncated cone is inclined at an angle of more than 45° to the longitudinal axis of the plug part.

Advantageously, the cylindrical locking pins of the socket part are held for displacement in locking slots of a receiving body of the socket part, wherein the locking slots are inclined at an angle of approximately 45° to the longitudinal axis of the plug receptacle. This facilitates the latching into place of the locking pins in the locking groove.

If the conical wall section of the locking groove has a cone angle of more than 90° at an inclination of the locking slots of approximately 45° to the longitudinal axis of the plug receptacle, then this results in the conical wall section of the locking groove being inclined in a direction towards the opposite wall section of the locking slots. This has the advantage that, when the plug part is under an axial pressure load, the locking pins are clamped between the conical wall section of the locking groove and the opposite wall section of the locking pins. Therefore, the locking pins cannot be pushed out of the locking groove when an axial pressure load acts on the plug part. Instead, the latched connection between the plug part and the socket part can only be disconnected when the plug part is not subject to an axial pressure load.

Advantageously, the cone angle of the conical wall section of the locking groove is 100° to 120°. The cone angle may be 110° in particular.

It is advantageous for the wall section of the locking groove having in cross section the shape of an arc to extend from the conical wall section to the fourth sliding guide region. With such a configuration, the wall section of the locking groove having in cross section the shape of an arc, in particular the shape of a circular arc, forms a fillet which is adjoined by the conical wall section in the direction towards the free end of the plug nipple.

It is advantageous if the wall section having in cross section the shape of an arc transitions into the fourth sliding guide region with a tangent that is radially oriented with respect to the longitudinal axis of the plug part.

As mentioned at the outset, the invention also relates to a plug-and-socket coupling for liquid conduits of a high-pressure cleaning apparatus having a plug part of the kind mentioned in the foregoing, and a socket part. The socket part comprises a receiving body having a plug receptacle into which the plug nipple is insertable, forming a liquid-tight connection, and which is disconnectably latchable together with the plug nipple, wherein the receiving body comprises two locking slots that are oriented at an incline to the longitudinal axis of the plug receptacle and lie diametrically opposite one another and each of which has a locking pin arranged for displacement therein, wherein the locking pins are movable from a locking position to a release position by way of a sliding sleeve which is displaceable in an axial direction on the receiving body, against the action of a resilient return force, wherein in the locking position the locking pins enter the locking groove of the plug nipple and in the release position release the locking groove, wherein the plug receptacle comprises a first circular-cylindrical receiving section which forms a sealing surface and receives the first sliding guide section of the plug nipple in a form-locking manner, and a second circular-cylindrical receiving section which has the locking slots opening thereinto and which receives the second sliding guide section of the plug nipple in a form-locking manner.

For establishing a liquid-tight and disconnectable connection, the plug nipple of the plug part can be inserted into the associated plug receptacle of the receiving body of the socket part. The plug receptacle comprises a first receiving section, the internal diameter of which is adapted to the external diameter of the first sliding guide section of the plug nipple. Furthermore, the plug receptacle comprises a second receiving section, the internal diameter of which is adapted to the external diameter of the second sliding guide section of the plug nipple. The first receiving section forms a sealing surface against which the sealing ring arranged in the first sliding guide section is contactable in a liquid-tight manner. The locking slots, each receiving a cylindrical locking pin, open into the second receiving section. The locking pins have a spring force applied thereto by a spring element. As long as the plug nipple is not inserted in the plug receptacle, the locking pins assume a locking position by virtue of the spring force acting on them. When the plug nipple is inserted into the plug receptacle, the first sliding guide section can first be passed through the second receiving section of the plug receptacle. The first sliding guide section then meets the first receiving section so that it can slide along the inner side of the first receiving section, and the second sliding guide section can slide along the inner side of the second receiving section. When the plug nipple is inserted into the plug receptacle, the locking pins, which are initially in their locking position, are spread apart against the resilient return force acting on them so that they can slide along the outer side of the plug nipple, and once the locking groove is positioned at the level of the mouth region of the locking slots, the locking pins latch into place in the locking groove.

If the latched connection between the plug part and the socket part is to be disconnected, the locking pins can, by way of a sliding sleeve displaceable in an axial direction by the user, be transferred to their release position in which they release the locking groove.

It is particularly advantageous if, when the plug nipple is inserted into the plug receptacle, the first sliding guide section comes into contact against the first receiving section and the second sliding guide section comes into contact against the second receiving section simultaneously. This provides a particularly reliable way of preventing the plug nipple from canting when it is being inserted into the plug receptacle because the plug nipple is in contact against two regions of the plug receptacle axially spaced apart from each other and is therefore aligned in line with the plug receptacle when the first sliding guide section enters the first receiving section and the second sliding guide section simultaneously enters the second receiving section.

Between the circular-cylindrical first receiving section and the circular-cylindrical second receiving section, in an advantageous configuration of the invention the plug receptacle comprises a conical guide section via which the inner diameter of the plug receptacle is continuously reduced starting from the second receiving section in a direction towards the first receiving section. The conical guide section serves to guide the plug nipple in the area between the second receiving section and the first receiving section. The free end of the plug nipple can slide along the inner side of the conical guide section when inserted into the plug receptacle so that the orientation of the plug nipple adapts to the orientation of the first receiving section.

It is advantageous for each locking slot to have a slot wall section against which a locking pin in the locking position is in contact at a pin portion thereof protruding from the associated locking groove, wherein the slot wall section has an angle of inclination to the longitudinal axis of the plug nipple that is equal to or less than the angle of inclination of a conical wall section of the locking groove lying opposite the slot wall section. As has already been explained in the foregoing, the locking groove in an advantageous configuration of the plug part comprises a conical wall section. The angle of inclination of the conical wall section with respect to the longitudinal axis of the plug part is advantageously at least as great as the angle of inclination of a slot wall section against which a locking pin in the locking position is in contact at a pin portion thereof protruding from the locking groove. Thus, when in the locking position, the locking pins each assume a position between a conical wall section of the locking groove and a slot wall section of a locking slot.

Preferably, the angle of inclination of the conical wall section with respect to the longitudinal axis of the plug part is greater than the angle of inclination of the opposite slot wall section. In such a configuration, the locking pin is wedged between the conical wall section and the slot wall section opposite thereto so that it cannot escape from the locking groove when the plug part is under an axial pressure load. The axial pressure load on the plug part is directed towards the end face thereof in particular and attempts to urge the plug nipple out of the plug receptacle. However, because the locking pins are clamped between the conical wall section of the locking groove and the opposite slot wall section of the locking slots when under the influence of the axial pressure load, the latched connection between the plug part and the socket part cannot readily be disconnected under the influence of the axial pressure load.

In an advantageous configuration of the invention, the angle of inclination of the slot wall sections of the locking slots with respect to the longitudinal axis of the plug nipple is no greater than 45° and the angle of inclination of the conical wall section relative to the longitudinal axis of the plug nipple is preferably at least 45°, in particular at least 50°, for example 55°.

The following description of a preferred embodiment of the invention, taken in conjunction with the drawings, serves to explain the invention in greater detail.

### BRIEF DESCRIPTION OF THE DRAWINGS

FIG. 1 is a longitudinal sectional view of a plug-and-socket coupling for liquid conduits of a high-pressure cleaning apparatus, showing a plug part inserted in a socket part and latched together with the socket part;

FIG. 2 shows a longitudinal sectional view of the plug part of FIG. 1;

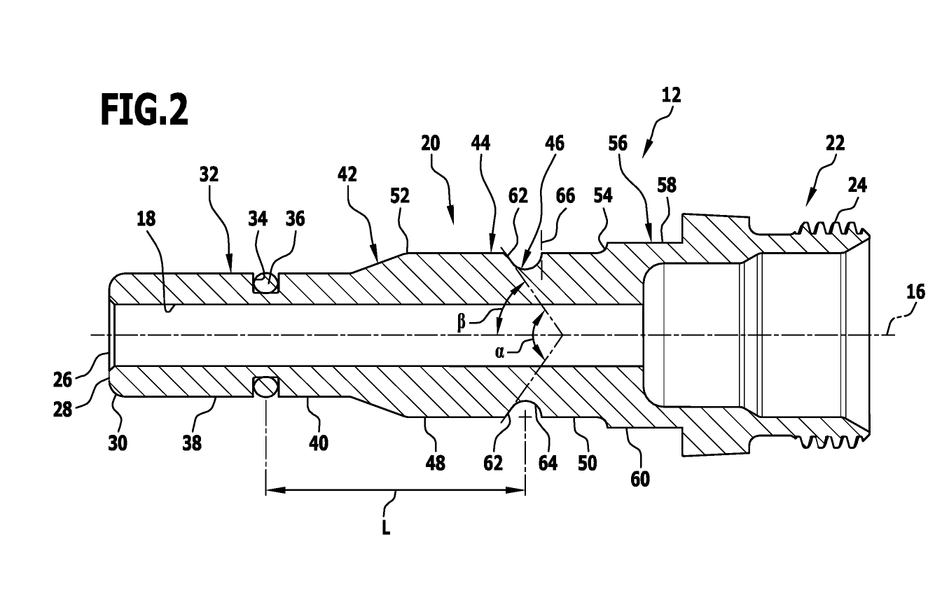

FIG. 3 shows a longitudinal sectional view of the socket part of FIG. 1;

FIG. 4 shows a perspective representation of a receiving body of the socket part of FIG. 1;

FIG. 5 is a representation of how the plug part and the receiving body cooperate for establishing a latched connection;

FIG. 6 is a longitudinal sectional view of the plug-and-socket coupling of FIG. 1 with the plug part shown as assuming a first intermediate position during insertion thereof into a plug receptacle of the receiving body;

FIG. 7 is a longitudinal sectional view corresponding to FIG. 6 but with the plug part shown as assuming a second intermediate position during insertion thereof into the plug receptacle;

FIG. 8 is a longitudinal sectional view corresponding to FIG. 6 but with the plug part shown as assuming a third intermediate position during insertion thereof into the plug receptacle.

### DETAILED DESCRIPTION OF THE INVENTION

The drawing shows a schematic representation of an advantageous embodiment of a plug-and-socket coupling for liquid conduits of a high-pressure cleaning apparatus in accordance with the invention, generally designated by the reference numeral 10. The plug-and-socket coupling 10 comprises a plug part 12 and a socket part 14. The plug part 12 and the socket part 14 can easily be connected together in a liquid-tight manner without using a special tool and can be separated again from each other without a special tool as required.

The plug part 12 has a longitudinal axis 16 and has extending therethrough a through-channel 18 in coaxial relation with the longitudinal axis 16. The through-channel 18 permits liquid under high pressure, in particular water under high pressure, to flow therethrough. The liquid can have a pressure of more than 100 bar, in particular a pressure of more than 150 bar. It may be provided for the liquid to have a pressure of more than 300 bar.

The plug part 12 forms a plug nipple 20 which is connected in one piece to a plug connecting part 22. The plug connecting part 22 has an external thread 24 and can be screwed together in a liquid-tight manner with a liquid conduit, for example with a connection fitting of a high-pressure hose or with a liquid discharge member, in particular a spray lance.

The plug nipple 20 is rotationally symmetric with respect to the longitudinal axis 16 and forms at a free end 26 thereof facing away from the plug connecting part 22 an end face 28 which transitions via a rounded enlargement portion 30 into a circular-cylindrical first sliding guide section 32. Arranged within the first sliding guide section 32 is a sealing ring groove 34 which is U-shaped in cross section and receives a sealing ring 36. The first sliding guide section 32 forms a first sliding guide region 38 on the side of the sealing ring groove 34 that faces towards the end face 28, and the first sliding guide section 32 forms a second sliding guide region 40 on the side of the sealing ring groove 34 that faces away from the end face 28. The external diameter of the first circular-cylindrical sliding guide region 38 is identical to the external diameter of the second circular-cylindrical sliding guide region 40. The length of the first sliding guide region 38 is greater than the length of the second sliding guide region 40.

Adjoining the second sliding guide region 40 is a transition section 42 of conical configuration, the external diameter of which widens continuously with increasing distance from the end face 28.

Adjoining the transition section 42 is a second circular-cylindrical sliding guide section 44, the external diameter of which is one-third larger than the external diameter of the first sliding guide section 32.

Arranged within the second sliding guide section 44 is a locking groove 46 which extends over the entire circumference of the second sliding guide section 44. The distance between the center of the sealing ring groove 34 and the center of the locking groove 46 is approximately 2.0 to 2.1 times the external diameter of the first sliding guide section 32 in the illustrated exemplary embodiment.

The second sliding guide section 44 forms a third circular-cylindrical sliding guide region 48 on the side of the locking groove 46 that faces towards the end face 28, and the second sliding guide section 44 forms a fourth circular-cylindrical sliding guide region 50 on the side of the locking groove 46 that faces away from the end face 28. The external diameter of the third sliding guide region 48 is identical to the external diameter of the fourth sliding guide region 50. The length of the third sliding guide region 48 is greater than the length of the sliding guide region 50.

The transition section 42 extends from the second sliding guide region 40 to the third sliding guide region 48. The distance of the end face 28 to the end 52 of the transition section 42 that faces away from the end face 28 is approximately 2.5 times the external diameter of the first sliding guide section 32 in the illustrated exemplary embodiment.

Adjoining the second sliding guide section 44 via a radially outwardly pointing shoulder 54, in a direction facing away from the free end 26, is a plug section 56 which has two flattened regions 58, 60 located opposite one another and oriented parallel to one another.

Adjoining the plug section 56 in the direction facing away from the end face 28 is the plug connecting part 22.

The locking groove 46 comprises a conical wall section 62 which immediately adjoins the third sliding guide region 48 and has a cone angle α of approximately 110°. The conical wall section 62 has an angle of inclination β of approximately 55° with respect to the longitudinal axis 16.

Adjoining the conical wall section 62 is a wall section 64 of the locking groove 46 having in cross section the shape of a circular arc. The circular arc shaped wall section 64 extends from the conical wall section 62 to the fourth sliding guide region 50. The circular arc shaped wall section 64 transitions into the fourth sliding guide region 50 with a tangent 66 oriented perpendicularly to the longitudinal axis 16, i.e. oriented in a radial direction.

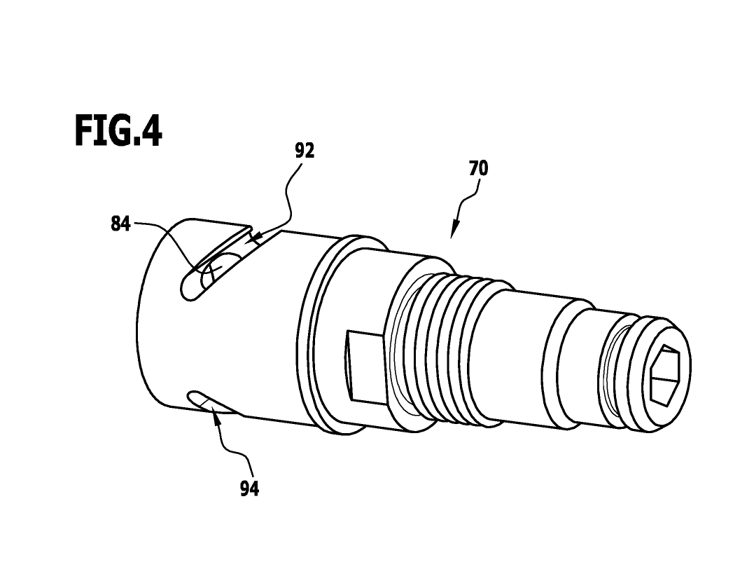

The socket part 14 comprises a receiving body 70, shown in a perspective view in FIG. 4. The receiving body 70 comprises a plug receptacle 72 into which the plug nipple 20 can be inserted for establishing a liquid-tight and disconnectable connection. Adjoining the plug receptacle 72 via a radially inwardly directed step 74 is a through-channel 76 of the receptacle body 70.

The plug receptacle 72 comprises a first circular-cylindrical receiving section 78 which adjoins the step 74 in the direction facing away from the through-channel 76. Adjoining the first receiving section 78 via a short intermediate section 80 is a conical guide section 82 which extends to a second circular-cylindrical receiving section 84. The internal diameter of the conical guide section 82 increases with increasing distance from the first receiving section 78.

The second receiving section 84 extends to an introduction section 86 of the plug receptacle 72. The introduction section 86 extends to the end 88 of the receiving body 70 that faces away from the through-channel 76.

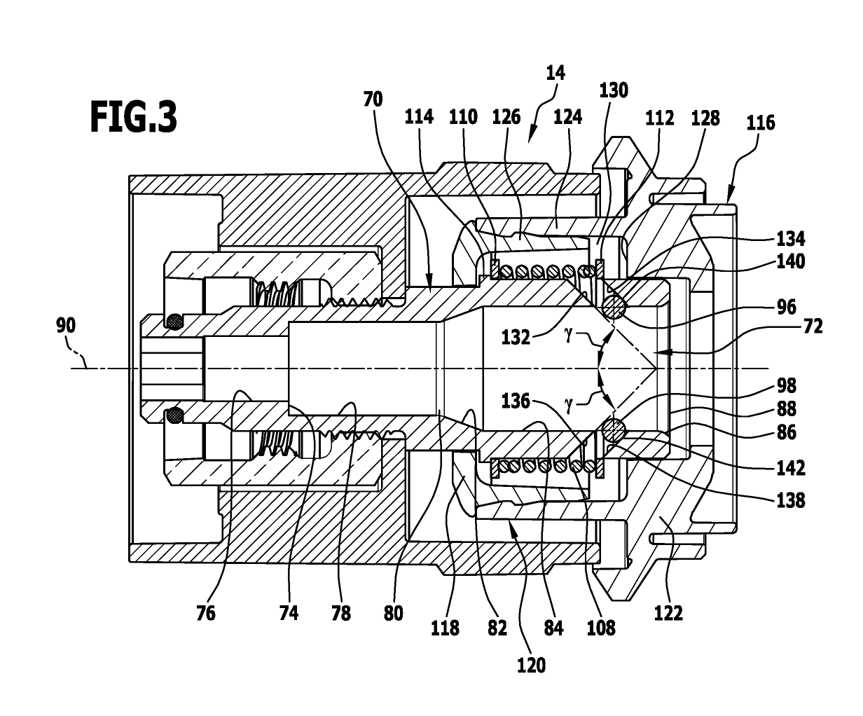

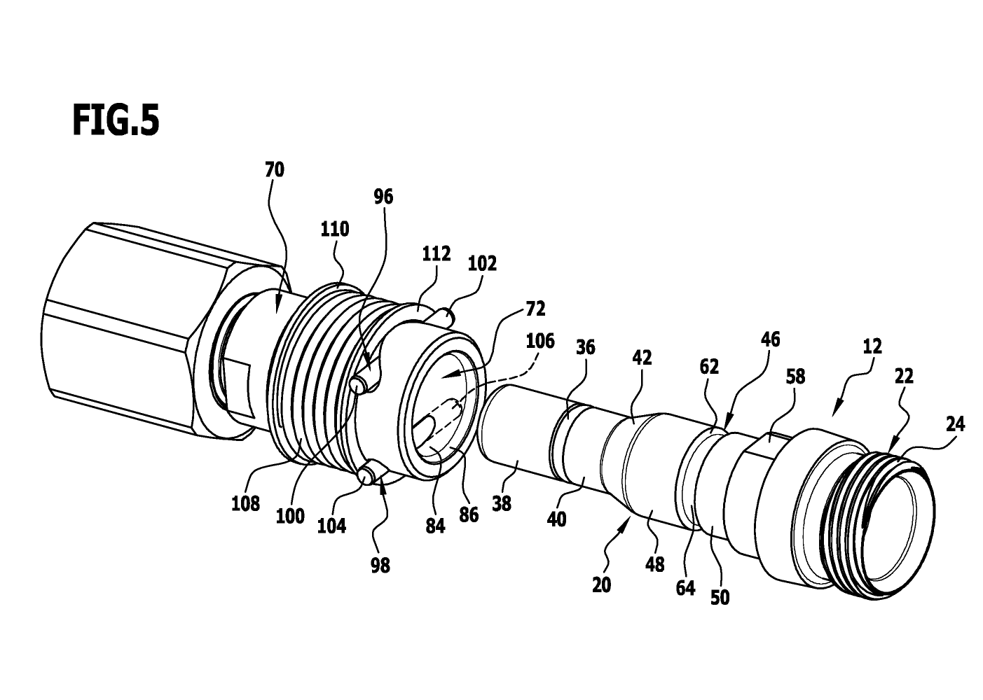

As can be seen from FIGS. 3 and 4 in particular, the receiving body 70 comprises two locking slots 92, 94 oriented at an incline to the longitudinal axis 90 of the receiving body 70, said locking slots 92, 94 opening to the second receiving section 84. A cylindrical locking pin 96, 98 is arranged for displacement in each of the locking slots 92, 94 respectively. The locking pins 96, 98 are oriented parallel to each other and lie diametrically opposite one another. The locking pins 96, 98 have their free ends 100, 102 and 104, 106 respectively protrude from the locking slots 92, 94. This is shown in FIG. 5.

At the level of the second receiving section 84, the receiving body 70 is surrounded by a coil spring 108 which is clamped between a first ring disk 110 and a second ring disk 112. The first ring disk 110 is supported on an outer enlargement 114 of the receiving body 70, and the second ring disk 112 is supported on the free ends 100, 102, 104 and 106 of the locking pins 96, 98 protruding from the receiving body 70. The locking pins 96, 98 have a spring force applied thereto via the second ring disk 112, under the action of which they assume their locking position, depicted in FIG. 3, unless the plug part 12 is inserted in the plug receptacle 72.

At the level of the second receiving section 84, a sliding sleeve 116 is supported for displacement in an axial direction on the outer side of the receiving body 70. The sliding sleeve 116 has been removed for greater clarity in FIG. 5. The sliding sleeve 116 has a rear end section 118 which engages behind the outer enlargement 114 of the receiving body 70. Adjoining the rear end section 118 is a cylinder shell 120 which surrounds the coil spring 108 and the two ring disks 110, 112 in a circumferential direction and which is adjoined by a front end section 122 of the sliding sleeve 116. The cylinder shell 120 is formed by a shell outer wall 124 and a shell inner wall 126 which are latched together. The shell outer wall 124 is connected in one piece to the front end section 122, and the shell inner wall 126 is connected in one piece to the rear end section 118.

The front end section 122 forms a bottom wall 128 of an annular space 130 which is defined by the sliding sleeve 116 and the receiving body 70 and in which the coil spring 108 and the two ring disks 110, 112 are arranged. The free ends 100, 102, 104 and 106 of the locking pins 96, 98 protruding from the locking slots 92, 94 are in contact against the bottom wall 128.

The locking pins 96, 98 can be moved from their locking position to a release position by way of the sliding sleeve 116. To this end, the user can manually displace the sliding sleeve 116 against the action of a return force of the coil spring 108 so that the locking pins 96, 98 are moved to a release position in which they assume a greater distance from each other than when in the locking position.

The locking slots 92, 94 each have two slot walls 132, 134 and 136, 138 respectively, oriented parallel to each other. In the illustrated exemplary embodiment, the slot walls are inclined at an angle of inclination γ to the longitudinal axis 90 of the receiving body 70. The inclination angle γ is 45° in the exemplary embodiment illustrated.

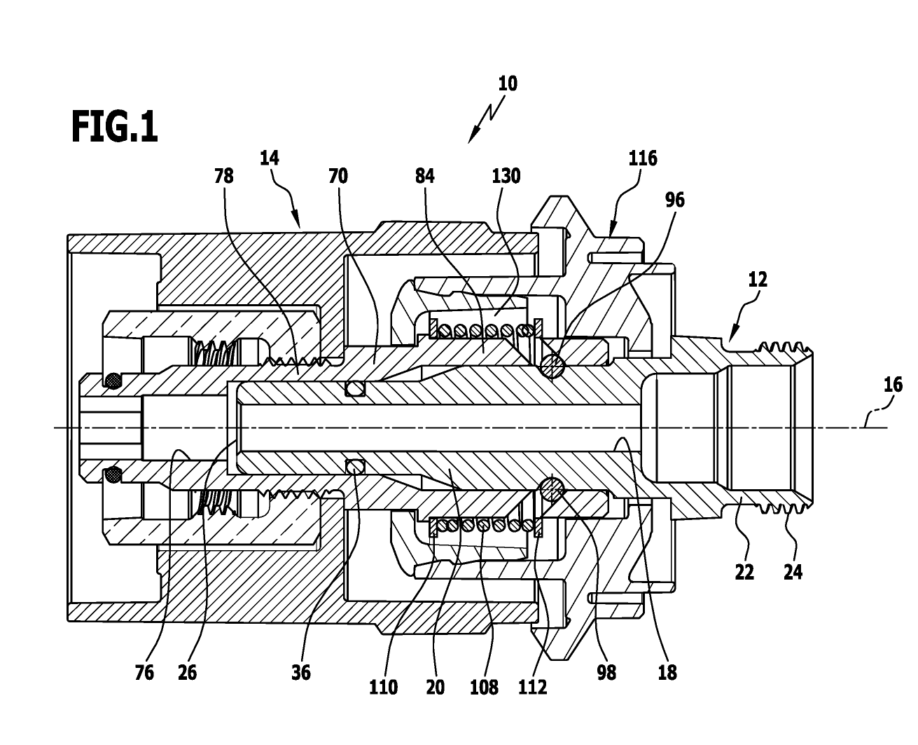

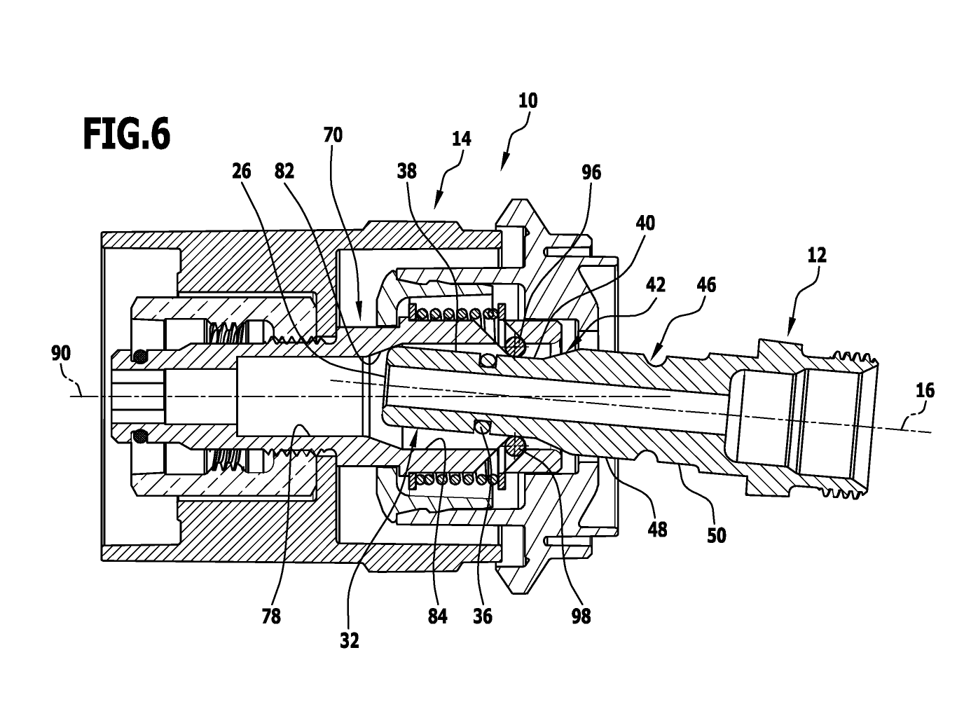

As has already been mentioned, the plug nipple 20 can be inserted into the plug receptacle 72 for establishing a liquid-tight and disconnectable connection. FIGS. 6, 7 and 8 show different intermediate positions which the plug nipple 20 assumes during insertion into the plug receptacle 72, and FIG. 1 shows the final position of the plug nipple 20 after insertion into the plug receptacle 72. The first sliding guide section 32 can first be passed through the introduction section 86 and through the second receiving section 84 adjoining thereto. The external diameter of the first sliding guide section 32 is considerably less than the internal diameter of the second receiving section 84 so that the plug nipple 20 can be inserted into the second receiving section 84 even if the longitudinal axis 16 of the plug part is inclined with respect to the longitudinal axis 90 of the receiving body 70. This is shown in FIG. 6.

Upon further insertion into the plug receptacle 72, the free end 26 of the plug part meets the conical guide section 82 of the plug receptacle 72 and is then able to slide along the conical guide section 82, whereby the orientation of the longitudinal axis 16 of the plug part 12 increasingly approaches the orientation of the longitudinal axis 90 of the receiving body 70.

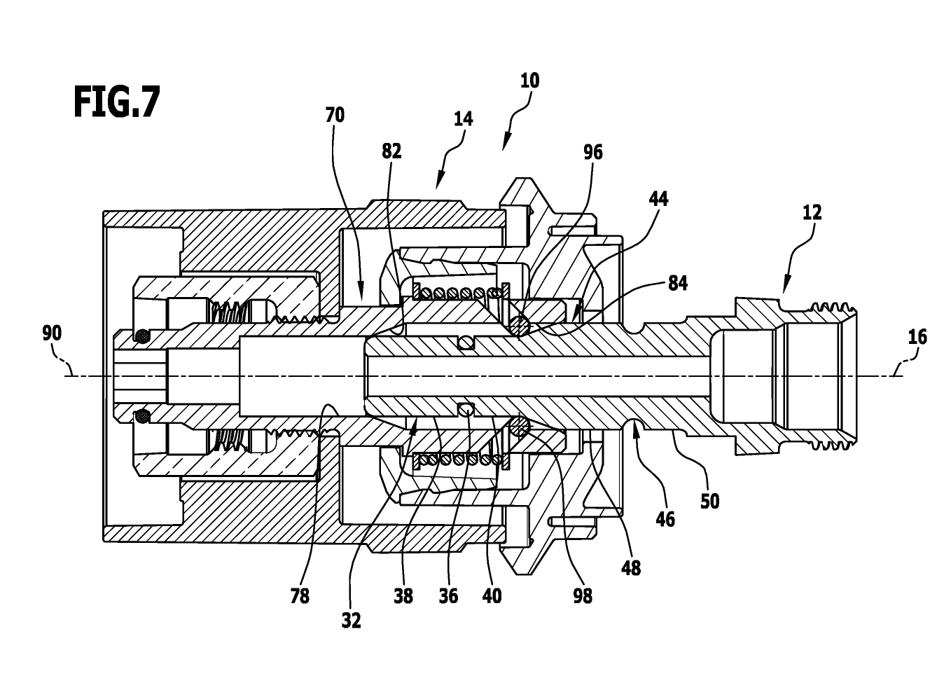

When the first sliding guide section 32 meets the first receiving section 78, as is shown by FIG. 7, the second sliding guide section 44 then simultaneously meets the second receiving section 84. As a result, the longitudinal axis 16 of the plug part 12 is aligned coaxially with the longitudinal axis 90 of the receiving body 70 and the plug part 12 is supported on the receiving body 70 on two regions thereof that are arranged in axially spaced relation to one another. The first sliding guide section 32 can now readily be inserted into the first receiving section 78 while, simultaneously, the second sliding guide section 44 can readily be inserted into the second receiving section 84, with no risk of the plug part 12 canting.

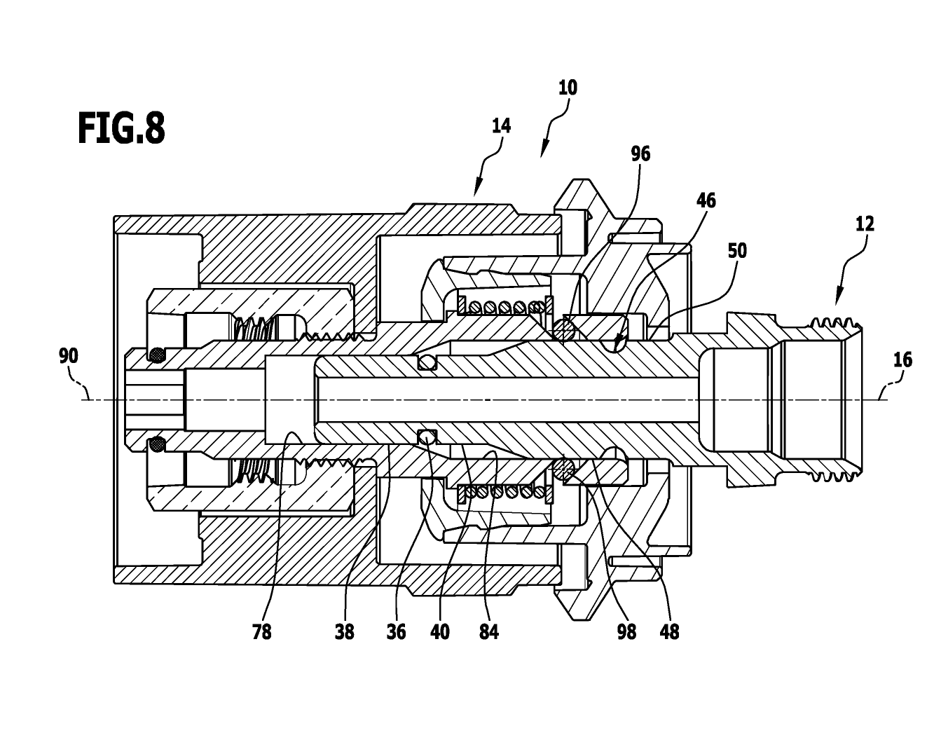

Upon further insertion of the plug nipple 20 into the plug receptacle 72, the sealing ring 36 is received by the first receiving section 78. This is shown in FIG. 8. The reception of the sealing ring 36 by the first receiving section 78 can be haptically sensed by the user, i.e. he or she is provided with feedback indicating that a liquid-tight connection has now been established between the plug part 12 and the socket part 14.

Only once the sealing ring 36 has assumed a position in the first receiving section 78 does the locking groove 46 reach the mouth region of the locking slots 92, 94 so that the resiliently biased locking pins 96, 98 can latch into place in the locking groove 46. Prior to this, the locking pins 96, 98 were hit and pushed apar<t from their locking position by the transition section 42, whereby they were guided along the outer side of the transition section 42 and then along the outer side of the second sliding guide section 44.

When the locking pins 96, 98 are latched in place in the locking groove 46, the plug nipple 20 is in its final position; this is depicted in FIG. 1. The latching of the locking pins 96, 98 into place in the locking groove 46 can also be haptically sensed by the user.

When liquid under high pressure flows through the through-channel 18 of the plug part 12 and the through-channel 76 of the receiving body 70, said liquid exerts an axially acting pressure load on the end face 28 of the plug nipple 20 so that the plug nipple 20 is urged in the direction facing away from the through-channel 76. Under the influence of the pressure load, the locking pins 96, 98 are in each case urged, by the conical wall section 62 of the locking groove 46, against a slot wall section 140 and 142 respectively, located opposite the conical wall section 62, of the locking slots 92, 94. The slot wall sections 140, 142 are inclined at an angle of inclination γ of 45° with respect to the longitudinal axis 16 of the plug part 12 and the longitudinal axis 90 of the receiving body 70 oriented collinearly therewith, whereas the conical wall section 62 of the plug part 12 is inclined at an angle β of 55° to said longitudinal axes as has already been explained. The slot wall sections 140, 142 and the conical wall section 62 thus form wedge surfaces oriented in inclined relationship to each other that receive, and press, the locking pins 96, 98 therebetween. Therefore, the locking pins 96, 98 cannot move from their locking position to their release position while under an axial pressure load, even if the user inadvertently actuates the sliding sleeve 116. The latched connection between the plug part 12 and the socket part 14 thus locks automatically when under an axial pressure load and can only be disconnected when the user removes the axial pressure load by, for example, switching off a high-pressure pump that causes the axial pressure load.

1. A plug part for a plug-and-socket coupling for liquid conduits of a high-pressure cleaning apparatus, wherein the plug part comprises a through-channel for liquid under high pressure extending coaxially with respect to the longitudinal axis of the plug part and wherein the plug part forms a plug nipple which is insertable into an associated plug receptacle of a socket part of the plug-and-socket coupling, forming a liquid-tight connection, and is disconnectably latchable together with the plug receptacle, wherein the plug nipple comprises a circular-cylindrical first sliding guide section in which is arranged a sealing ring groove extending therearound in a circumferential direction, said sealing ring groove having a sealing ring therein, and wherein the plug nipple comprises a circular-cylindrical second sliding guide section and a latching receptacle into which are latchable two spring-loaded cylindrical locking pins of the socket part that are oriented parallel to each other and lie diametrically opposite one another, wherein the second sliding guide section has an external diameter which is at least one-quarter larger than the external diameter of the first sliding guide section, and wherein the latching receptacle is arranged in the second sliding guide section and is configured as a locking groove extending therearound in a circumferential direction, wherein the distance between the center of the sealing ring groove and the center of the locking groove is at least one and a half times the external diameter of the first sliding guide section.

2. The plug part in accordance with claim 1, wherein the distance between the center of the sealing ring groove and the center of the locking groove is at least twice the external diameter of the first sliding guide section.

3. The plug part in accordance with claim 1, wherein the external diameter of the second sliding guide section is no greater than one and a half times the external diameter of the first sliding guide section.

4. The plug part in accordance with claim 1, wherein the external diameter of the second sliding guide section is one-third larger than the external diameter of the first sliding guide section.

5. The plug part in accordance with claim 1, wherein the plug nipple comprises a transition section between the first sliding guide section and the second sliding guide section.

6. The plug part in accordance with claim 5, wherein the diameter of the transition section widens continuously with increasing distance from the free end of the plug nipple.

7. The plug part in accordance with claim 6, wherein the transition section is of conical configuration.

8. The plug part in accordance with claim 5, wherein the plug nipple comprises at the free end thereof an end face whose distance to the end of the transition section facing away from the end face is at least twice the size of the external diameter of the first sliding guide section.

9. The plug part in accordance with claim 1, wherein the first sliding guide section forms a first sliding guide region and a second sliding guide region, wherein the first sliding guide region is arranged on the side of the sealing ring groove facing towards the free end of the plug nipple and wherein the second sliding guide region is arranged on the side of the sealing ring groove facing away from the free end of the plug nipple.

10. The plug part in accordance with claim 9, wherein the first sliding guide region is longer than the second sliding guide region.

11. The plug part in accordance with claim 1, wherein the second sliding guide section forms a third sliding guide region and a fourth sliding guide region, wherein the third sliding guide region is arranged on the side of the locking groove facing towards the free end of the plug nipple and wherein the fourth sliding guide region is arranged on the side of the locking groove facing away from the free end of the plug nipple.

12. The plug part in accordance with claim 11, wherein the third sliding guide region is longer than the fourth sliding guide region.

13. The plug part in accordance with claim 11, wherein the locking groove comprises a conical wall section which adjoins the third sliding guide region and the diameter of which decreases with increasing distance from the third sliding guide region and which is adjoined by an arcuate wall section of the locking groove.

14. The plug part in accordance with claim 13, wherein the cone angle of the conical wall section is at least 90°, in particular more than 90°.

15. The plug part in accordance with claim 14, wherein the cone angle is 100° to 120°.

16. The plug part in accordance with claim 13, wherein the arcuate wall section extends to the fourth sliding guide region.

17. The plug part in accordance with claim 16, wherein the arcuate wall section transitions into the fourth sliding guide region with a tangent that is radially oriented with respect to the longitudinal axis of the plug part.

18. A plug-and-socket coupling for liquid conduits of a high-pressure cleaning apparatus having a plug part in accordance with claim 1 and having a socket part which comprises a receiving body having a plug receptacle into which the plug nipple is insertable, forming a liquid-tight connection, and which is disconnectably latchable together with the plug nipple, wherein the receiving body comprises two locking slots that are oriented at an incline to the longitudinal axis of the plug receptacle and lie diametrically opposite one another and each of which has a cylindrical locking pin arranged for displacement therein, wherein the locking pins are movable from a locking position to a release position by way of a sliding sleeve which is displaceable in an axial direction on the receiving body, against the action of a resilient return force, wherein in the locking position the locking pins enter the locking groove of the plug nipple and in the release position release the locking groove, wherein the plug receptacle comprises a first circular-cylindrical receiving section which forms a sealing surface and receives the first sliding guide section of the plug nipple in a form-locking manner, and wherein the plug receptacle comprises a second circular-cylindrical receiving section which has the locking slots opening thereinto and which receives the second sliding guide section of the plug nipple in a form-locking manner.

19. The plug-and-socket coupling in accordance with claim 18, wherein, when the plug nipple is inserted into the plug receptacle, the first sliding guide section comes into contact against the first receiving section and the second sliding guide section comes into contact against the second receiving section simultaneously.

20. The plug-and-socket coupling in accordance with claim 18, wherein each locking slot has a slot wall section against which a locking pin in the locking position is in contact at a pin portion thereof protruding from the associated locking groove, wherein the slot wall section is oriented at an angle of inclination to the longitudinal axis of the plug nipple that is equal to or less than the angle of inclination of a conical wall section of the locking groove lying opposite the slot wall section.

21. The plug-and-socket coupling in accordance with claim 20, wherein the angle of inclination of the slot wall section is no greater than 45° and the angle of inclination of the conical wall section is at least 45°.
